(19) United States
(12) Patent Application Publication
(10) Pub. No.: US 2015/0148425 A1
(43) Pub. Date: May 28, 2015

(54) ANTIMICROBIAL COMPOSITION EXHIBITING INCREASED EFFICACY

(71) Applicant: The Dial Corporation, Scottsdale, AZ (US)

(72) Inventors: Janice L. Fuls, Fountain Hills, AZ (US); Nancy D. Rodgers, Chandler, AZ (US)

(73) Assignee: The Dial Corporation, Scottsdale, AZ (US)

(21) Appl. No.: 14/089,091

(22) Filed: Nov. 25, 2013

(51) Int. Cl. A01N 25/30; A01N 33/12

(52) U.S. Cl. CPC A01N 25/30; A01N 33/12
USPC 514/643

(57) ABSTRACT

Materials and apparatus are provided that exhibit increased efficacy. An antimicrobial composition includes a cationic active ingredient disposed within the antimicrobial composition. Further, the antimicrobial composition includes a lauramine oxide surfactant, the lauramine oxide surfactant comprising 0.9 to 1.9 weight percent of the antimicrobial composition. Further, the antimicrobial composition includes a number of co-surfactants, the co-surfactant comprising cocamidopropyl betaine, sunfloweramidopropyl ethonium sulfate, PEG-120 methyl glucose dioleate, lauryl/myristyl amidopropyl amine oxide, lauramidopropylamine oxide, or combinations thereof. Still further, the antimicrobial composition includes a thickener, the thickener comprising hydromethylcellulose, PEG-120 methyl glucose, cocamide MEA, hydroxypropyl methylcellulose or combinations thereof.

### FIELD OF THE INVENTION

The present invention generally relates to a composition to enhance bacterial elimination, and more particularly relates to an antimicrobial composition exhibiting increased efficacy.

### BACKGROUND OF THE INVENTION

In any given day an individual may encounter multiple instances of bacterial life or other microorganisms, some of which may be harmful to the person. For example, raw meat may be a breeding ground for bacteria which, if ingested, may cause illness. Antibacterial agents are personal care products that are used to inhibit bacteria growth, kill bacteria, or combinations thereof. For example, an antimicrobial soap may be used to wash skin that has come in contact with bacteria to neutralize the bacteria's harmful effects.

Accordingly, it is desirable to have an antimicrobial composition that has high efficacy in killing bacteria, or inhibiting bacteria growth when such an antimicrobial composition is used on the skin. Additionally, it is desirable to have an antimicrobial composition that is safe for the environment and consumer use and that is compatible with other soap ingredients that deliver a satisfactory consumer experience. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An antimicrobial composition exhibiting increased efficacy includes a cationic active ingredient disposed within the antimicrobial composition. The composition includes a lauramine oxide surfactant, the lauramine oxide surfactant comprising 0.9 to 1.9 weight percent of the antimicrobial composition. The composition includes a number of co-surfactants, the co-surfactant comprising cocamidopropyl betaine, sunfloweramidopropyl ethonium sulfate, PEG-120 methyl glucose dioleate, lauryl/myristyl amidopropyl amine oxide, lauramidopropylamine oxide, or combinations thereof. The composition includes a thickener, the thickener comprising hydromethylcellulose, PEG-120 methyl glucose, cocamide MEA, hydroxypropyl methylcellulose, or combinations thereof.

An antimicrobial cleaning product exhibiting increased efficacy includes a container and an antimicrobial cleaning product housed within the container. The cleaning product includes a cationic active ingredient, a lauramine oxide surfactant, comprising 0.9 to 1.9 weight percent of the antimicrobial composition, a number of co-surfactants, the co-surfactant comprising cocamidopropyl betaine, sunfloweramidopropyl ethonium sulfate, PEG-120 methyl glucose dioleate, lauryl, myristyl amidopropyl, lauramidopropylamine oxide, or combinations thereof, and a thickener, the thickener comprising hydromethylcellulose, PEG-120 methyl glucose, cocamide MEA, hydroxypropyl methylcellulose, or combinations thereof. The cleaning product also includes an aqueous carrier to contain the antimicrobial cleaning product.

An antimicrobial composition exhibiting increased efficacy includes 0.10% to 0.20% by weight of a cationic active ingredient disposed within the antimicrobial composition. The composition also includes 0.9% to 1.9% by weight of a lauramine oxide surfactant disposed within the antimicrobial composition. The composition also includes a number of co-surfactants disposed within the antimicrobial composition. The composition also includes a thickener disposed within the antimicrobial composition.

### BRIEF DESCRIPTION OF THE DRAWINGS

The present invention will hereinafter be described in conjunction with the following drawing figures, wherein like numerals denote like elements, and

FIG. 1 is a diagram of an example of applying an antimicrobial cleaning product to skin according to the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

As described above, individuals come into contact with bacteria and other microorganisms on a day-to-day basis. Many of these bacterial compounds and other microorganisms may be harmful to humans. In one example, humans may come into contact with the bacteria via their skin. Bacteria on the skin can be harmful, and can also facilitate the ingestion of the bacteria, which may pose additional health risks. For example, a human preparing a meal may get bacteria on their hands from raw meat. As the fingers come into contact with the mouth, the bacteria may be ingested, and cause additional health problems for an individual. Accordingly, antimicrobial soaps are used to kill the bacteria that come into contact with skin, and to prevent further health problems for individuals who come in contact with the bacteria either directly, or indirectly.

While antimicrobial cleaning products may be beneficial, some antimicrobial cleaning products may exhibit less than satisfactory characteristics. For example, many antimicrobial active ingredients may be harmful to the environment and the individual. More specifically, some antimicrobial active ingredients, such as Triclosan have been criticized as being possible, environmental toxins, endocrine disrupters, toxins, and contributors to bacterial resistance. Other active ingredients, such as benzethonium chloride may also present other inefficiencies. For example, some antimicrobial soaps that include cationic actives such as benzethonium chloride may exhibit efficacy in in vitro type methods, yet may experience a reduction in efficacy when used on skin, or may be inactive when used on the skin. This may be due to the positively-charged cationic antimicrobial ingredients which may be neutralized by other ingredients found in cleansing formulas. The positively-charged cationic antimicrobial ingredient may also be neutralized by negatively-charged skin cells and the bacteria itself.

Accordingly, the principles described herein provide a composition for increasing the on-skin efficacy of an antimicrobial cleaning product that would otherwise exhibit a reduced ability to kill bacteria, or reduce bacteria growth as described above. More specifically, the principles described herein provide a formulation in which high antimicrobial efficacy, in the range of a 2 to 3 log reduction in a bacteria population, on the skin is exhibited. Such a composition may include a cationic active ingredient to kill bacteria, reduce bacteria growth, or combinations thereof. Moreover, the composition may also include a surfactant. The composition of this form may be beneficial in that it uses an environmentally-friendly and consumer-safe active ingredient while maintaining an ability to kill bacteria and reduce bacteria growth without negatively impacting other cleaning product ingredients.

Accordingly, the antimicrobial cleaning product is safe for consumers, safe for the environment, effectively kills bacteria on the skin, and maintains properties, that give the cleaning product good performance qualities and good aesthetic qualities.

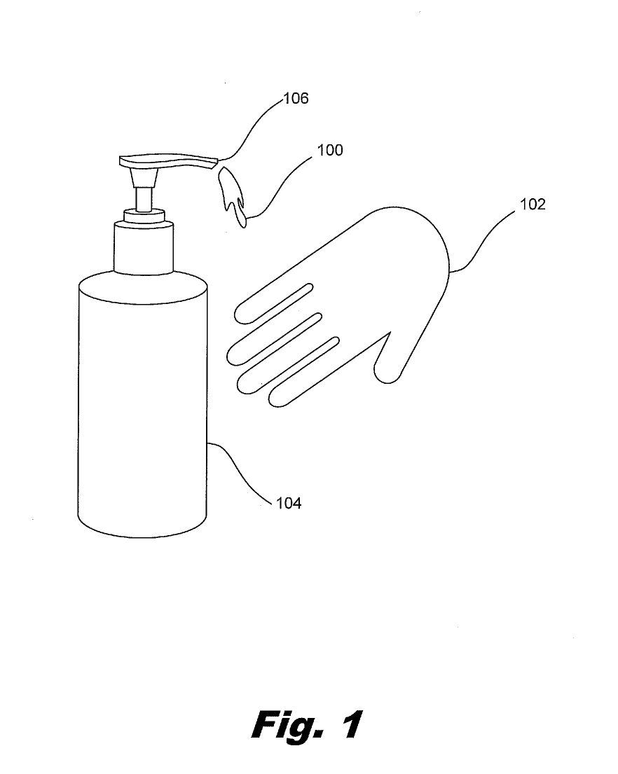

Turning now to the figures, FIG. 1 is a diagram of an example of applying an antimicrobial cleaning product (100) to skin (102) according to the principles described herein. As depicted in FIG. 1, the antimicrobial cleaning product (100) may be applied to a hand. However, the antimicrobial cleaning product (100) may also be configured to be applied on other skin surfaces such as the arms and face of an individual. As described above the antimicrobial cleaning product (100) may exhibit increased efficacy when used on the skin. As used in the present specification, and in the appended claims, efficacy may refer to the ability of an antimicrobial cleaning product (100) to reduce bacteria growth, or to kill bacteria. The efficacy of an antimicrobial cleaning product (100) may be measured using a logarithmic reduction scale or as a percent reduction in a bacteria population. For example, a 1 log reduction corresponds to a 90% reduction in the bacteria population. Similarly, a 2 log reduction corresponds to a 99% reduction in the bacteria population, a 3 log reduction corresponds to a 99.9% reduction in the bacteria population, a 4 log reduction corresponds to a 99.99% reduction in the bacteria population, and a 5 log reduction corresponds to a 99.999% reduction in the bacteria population.

In some examples, the antimicrobial cleaning product (100) may be held in a container (104) that has an opening (106) that allows the cleaning product (100) to flow out of the container (104) onto the skin (102). In one example, the container (104) is a pump-type container (104) that expels the cleaning product (100). For example, a user may depress a handle on the pump-type container (104) which actuates a pump that draws liquid up a siphon tube and expels the antimicrobial cleaning product (100) out of a nozzle opening (106) of the pump-type container (104).

The antimicrobial cleaning product (100) may include an antimicrobial composition. The antimicrobial composition may include an active ingredient that kills bacteria and other microorganisms that come into contact with the skin. The antimicrobial composition may also include a mechanism for delivering the antimicrobial composition onto the skin cells to interact with the bacteria cells. The antimicrobial composition may also include other ingredients to increase the “feel” and aesthetic qualities of the antimicrobial cleaning product. Such ingredients may include a dye, a fragrance, a preservative, a PH adjuster, an antiseptic, a humectant, skin conditioners, a thickener, a humectant, a conditioning agent, a chelating agent, a viscosity adjuster, a foam booster among other aesthetic enhancing ingredients. Specific examples of ingredients that may be used in the antimicrobial composition are given in more detail below. In some examples, the antimicrobial composition may be a gel-type composition. In this example, the composition may have a pH between 4.5 and 5.3. In other examples, the antimicrobial composition may be a foam-type composition. In this example, the foam-type composition may have a pH between approximately 5 and 6. The antibacterial cleaning product (100) may also include an aqueous carrier, such as water, to contain the antimicrobial cleaning product (100) ingredients. A more detailed description of the different ingredients in the antimicrobial composition is given as follows.

The antimicrobial composition may include a cationic active ingredient. The cationic active ingredient may be any positively charged ingredient that is used to kill bacteria or other microorganisms that come in contact with skin surfaces. For example, the cationic active ingredient may be benzethonium chloride. In another example, the cationic active ingredient may be benzalkonium chloride. In yet another example, the cationic active ingredient may be a combination of benzethonium chloride and benzalkonium chloride. The cationic active ingredient may comprise between 0.10 weight percent and 0.20 weight percent of the antimicrobial composition. Including a cationic active ingredient may be beneficial in that it is environmentally-friendly and safe for consumer use.

The antimicrobial composition may include a lauramine oxide surfactant. The lauramine oxide surfactant may enhance the deposition of the active ingredient, such as the benzethonium chloride on the skin. In some examples, the lauramine oxide may comprise between 0.9 weight percent to 1.9 weight percent of the antimicrobial composition. More specifically, the lauramine oxide surfactant may comprise 1.50 weight percent of the antimicrobial composition. The lauramine oxide surfactant may further assist in killing bacteria by lowering the surface tension of a liquid or the interfacial tension between two liquids or between a liquid and a solid. When added to the antimicrobial composition, the lauramine oxide surfactant significantly reduces the surface tension of the antimicrobial composition allowing the composition to penetrate the skin (102) rather than slide off the skin (102). The result is that the antimicrobial composition can function more effectively.

The antimicrobial composition may include a number of co-surfactants. A co-surfactant may enhance the ability of the lauramine oxide surfactant to reduce the surface tension of the antimicrobial composition. In some examples, the co-surfactant may be a zwitterionic surfactant. The co-surfactants included in the antimicrobial composition include cocamidopropyl betaine, sunfloweramidopropyl ethonium sulfate, PEG-120 methyl glucose dioleate, lauryl/myristyl amidopropyl amine oxide, lauramidopropylamine oxide, or combinations thereof.

The antimicrobial composition may also include a thickener to increase the “feel” of the antimicrobial cleaning product (100). The thickener may include hydromethylcellulose, PEG-120 methyl glucose, cocamide MEA, hydroxypropyl methylcellulose, or combinations thereof. In some examples, the antimicrobial cleaning product (100) may be Lauramide DEA free.

In some examples, the antimicrobial composition may include a zinc salt. Specific examples of zinc salts that may be included in the antimicrobial composition include zinc sulfate, zinc gluconate, or combinations thereof.

As indicated above, the antimicrobial composition and the antimicrobial cleaning product (100) described above may be beneficial in that an environmentally-friendly and consumer safe active ingredient is used, while maintaining the efficacy of the active ingredient. Maintaining the efficacy of the active ingredient may include using ingredients in the antimicrobial cleaning product (100) that reduces the neutralization of the active ingredient. Moreover, the antimicrobial cleaning product (100) as described herein is compatible with other ingredients that give the antimicrobial cleaning product (100) good performance characteristics and good aesthetic qualities. These benefits, in addition to others, are provided by the antimicrobial composition as described herein.

As indicated above, the antimicrobial composition and the antimicrobial cleaning product (100) may exhibit increased efficacy. Tables (1) and (3) illustrate the increased efficacy while Tables (2) and (4)-(8) give specific examples of antimicrobial compositions as described in the present specification.

As indicated by Table (1) below, antimicrobial compositions as described herein may exhibit increased efficacy during on-skin use. The results indicated in Table (1) were observed using a Health Care personnel Hand wash method. Table (1) indicates the logarithmic reduction in a Serratia marcescens bacteria population.

TABLE (1)

| | | Weight Percent | |
|---|---|---|---|
| | Active | of Active | S. marcescens |
| | Ingredient | Ingredient (%) | (log₁₀ reduction) |
| Commercial | Benzethonium | 0.20 | 1.70 |
| Product A | Chloride | | |
| Commercial | Benzethonium | 0.20 | 0.50 |
| Product B | Chloride | | |
| Commercial | Benzalkonium | 0.13 | 0.14 |
| Product C | Chloride | | |
| Commercial | Benzethonium | 0.20 | 1.06 |
| Product D | Chloride | | |
| Commercial | Benzalkonium | .015 | .047 |
| Product E | Chloride | | |
| Antimicrobial | Benzethonium | .017 | 2.44 |
| Composition 1 | Chloride | | |

As indicated by Table (1), none of the commercial products exhibited a log reduction of greater than 2.00 with the greatest being 1.06. By comparison, Antimicrobial Composition 1, an example of the antimicrobial composition as described herein, exhibits a log reduction of greater than 2. More specifically, Antimicrobial Composition 1 exhibited an efficacy in killing the S. marcescens bacteria population at a 2.44 log reduction level. As used in Table (1), Antimicrobial Composition 1, which is an example of the antimicrobial composition described herein, may include the following ingredients in the corresponding weight percentages as indicated in Table (2).

TABLE (2)

| Ingredient | Weight Percent |
|---|---|
| Water | QS |
| Benzethonium Chloride | 0.17 |
| Lauramine Oxide | 1.50 |
| Cocamidopropyl Betaine | 0.40 |
| Glycerin | 1.50 |
| Hydromethylcellulose | 0.25 |
| Sunfloweramidopropyl Ethonium Sulfate | 0.80 |
| Chlorhexidine Digluconate | 0.20 |
| Zing Gluconate | 0.02 |
| Citric Acid | 0.09 |
| EDTA | 0.02 |

As indicated in Table (2), benzethonium chloride may be the cationic active ingredient and lauramine oxide the lauramine oxide surfactant. Additionally, Antimicrobial Composition 1 may include cocamidopropyl betaine and sunfloweramidopropyl ethonium sulfate as co-surfactants and hydromethylcellulose as a thickener. In some examples, the antimicrobial composition may exhibit an accumulation effect. As used herein, an accumulation effect may refer to the characteristic of the antimicrobial composition to increase in efficacy over time. For example, in a Health Care personnel Hand wash method Antimicrobial Composition 1 exhibited a 3.08 log reduction in the S. marcescens bacteria population after ten washes.

In another example, as indicated by Table (3) below, antimicrobial compositions as described herein may exhibit increased efficacy during on-skin use. The results indicated in Table (3) were observed using a Health Care personnel Hand wash method. Table (3) indicates the logarithmic reduction in an Escherichia coli bacteria population.

TABLE (3)

| | | Weight Percent | |
|---|---|---|---|
| | Active | of Active | E. coli |
| | Ingredient | Ingredient (%) | (log₁₀ reduction) |
| Commercial | Benzalkonium | 0.13 | 1.91 |
| Product F | Chloride | | |
| Antimicrobial | Benzethonium | 0.13 | 2.63 |
| Composition 2 | Chloride | | |
| Antimicrobial | Benzethonium | 0.13 | 1.96 |
| Composition 3 | Chloride | | |
| Antimicrobial | Benzethonium | 0.10 | 2.42 |
| Composition 4 | Chloride | | |

As indicated by Table (3), none of the commercial products exhibited a log reduction of greater than 2.00 with the greatest being 1.91. By comparison, the antimicrobial compositions as described herein may exhibit a log reduction greater than the commercial product, with the lowest being 1.96, still greater than the commercial product.

As used in Table (3), Antimicrobial Composition 2, which is an example of the antimicrobial composition described herein, may include the following ingredients in the corresponding weight percentages as indicated in Table (4).

TABLE (4)

| Ingredient | Weight Percent |
|---|---|
| Water | QS |
| Benzethonium Chloride | 0.13 |
| Lauramine Oxide | 1.50 |
| Myristamine Oxide | 1.50 |
| Glycerin | 1.50 |
| Cetrimonium Chloride | 2.00 |
| PEG-120 Methyl Glucose Dioleate | 0.20 |
| Cocamide MEA | 1.00 |
| DMDM Hydantoin | 0.22 |
| Citric Acid | 0.75 |
| EDTA | 0.02 |
| Sodium Chloride | 1.30 |

As indicated in Table (4), benzethonium chloride may be the cationic active ingredient and lauramine oxide the lauramine oxide surfactant. Additionally, antimicrobial composition 2 may include PEG-120 Methyl Glucose Dioleate as a co-surfactant and cocamide MEA as a thickener.

As used in Table (3), Antimicrobial Composition 3, which is an example of the antimicrobial composition described herein, may include the following ingredients in the corresponding weight percentages as indicated in Table (5).

TABLE (5)

| Ingredient | Weight Percent |
|---|---|
| Water | QS |
| Benzethonium Chloride | 0.13 |
| Cocamidopropyl Betaine | 1.50 |
| Myristamine Oxide | 1.50 |
| Glycerin | 1.50 |
| Cetrimonium Chloride | 2.00 |
| PEG-120 Methyl Glucose Dioleate | 0.10 |
| Cocamide MEA | 1.00 |
| Citric Acid | 0.50 |
| Sodium Chloride | 1.20 |

As used in Table (3), Antimicrobial Composition 4, which is an example of the antimicrobial composition described herein, may include the following ingredients in the corresponding weight percentages as indicated in Table (6).

TABLE (6)

| Ingredient | Weight Percent |
|---|---|
| Water | QS |
| Benzethonium Chloride | 0.10 |
| Lauramine Oxide | 1.50 |
| Lauryl/Myristyl Amidopropyl Amine Oxide | 1.80 |
| Glycerin | 1.50 |
| Cetrimonium Chloride | 0.75 |
| PEG-120 Methyl Glucose Dioleate | 0.75 |
| Sodium Benzoate | 0.40 |
| Citric Acid | 0.75 |
| EDTA | 0.02 |
| Sodium Chloride | 1.25 |

As indicated in Table (6), benzethonium chloride may be the cationic active ingredient and lauramine oxide the lauramine oxide surfactant. Additionally, antimicrobial composition 4 may include PEG-120 Methyl Glucose Dioleate and lauryl/miristyl amidopropyl amine as co-surfactants.

In another example, the antimicrobial composition may include the following ingredients and corresponding weight percentages as indicated by Table (7).

TABLE (7)

| Ingredient | Weight Percent |
|---|---|
| Water | QS |
| Benzethonium Chloride | 0.10 |
| Lauramine Oxide | 1.20 |
| PEG-120 Methyl Glucose | 0.75 |
| Glycerin | 2.10 |
| Cetrimonium Chloride | 2.30 |
| Citric Acid | 0.70 |
| Lauramidopropylamine Oxide | 1.20 |
| Sodium Benzoate | 0.40 |
| Tetrasodium EDTA | 0.02 |
| Sodium Chloride | 1.00 |
| Cocamide MEA | 0.75 |

As indicated in Table (7), benzethonium chloride may be the cationic active ingredient and lauramine oxide the lauramine oxide surfactant. Additionally, the antimicrobial composition as indicated in Table (7) may include lauramidopropylamine oxide as a co-surfactant and PEG-120 Methyl Glucose and cocamide MEA as thickeners.

In yet another example, the antimicrobial composition may include the following ingredients and corresponding weight percentages as indicated by Table (8).

TABLE (8)

| Ingredient | Weight Percent |
|---|---|
| Water | QS |
| Benzethonium Chloride | 0.20 |
| Lauramine Oxide | 1.50 |
| Hydroxypropyl Methylcellulose | 0.25 |
| Glycerin | 1.50 |
| Sunflowerseedamidopropyl | 0.80 |
| Ethyldimonium Ethosulfate and PEG-9 | |
| Citric Acid | 0.10 |
| DMDM Hydantoin | 0.22 |
| Chlorhexidine Digluconate | 0.20 |
| Tetrasodium EDTA | 0.02 |
| Cocamidopropyl Betaine | 0.40 |
| Zinc Sulfate | 0.05 |

As indicated in Table (8), benzethonium chloride may be the cationic active ingredient and lauramine oxide the lauramine oxide surfactant. Additionally, the antimicrobial composition as indicated in Table (8) may include cocoamidopropyl betaine as a co-surfactant.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An antimicrobial composition exhibiting increased efficacy, comprising:
a cationic active ingredient comprising benzethonium chloride at a concentration of 0.1 to 0.2 weight percent of the antimicrobial composition;
a lauramine oxide surfactant, at a concentration of 0.9 to 1.9 weight percent of the antimicrobial composition;
one or more co-surfactants selected from the group consisting of cocamidopropyl betaine, sunfloweramidopropyl ethonium sulfate, PEG-120 methyl glucose dioleate, lauryl/myristyl amidopropyl amine oxide, and lauramidopropylamine oxide; and
one or more thickeners selected from the group consisting of hydromethylcellulose, PEG-120 methyl glucose, cocamide MEA, and hydroxypropyl methylcellulose,
wherein the antimicrobial composition causes at least a log 2 reduction in a bacterial population on a skin surface.

2-3. (canceled)

4. The antimicrobial composition of claim 1, in which the antimicrobial composition exhibits an accumulation effect after multiple uses.

5. The antimicrobial composition of claim 1, further comprising a dye, a fragrance, a preservative, a PH adjuster, an antiseptic, a humectant, or combinations thereof.

6. The antimicrobial composition of claim 1, in which the lauramine oxide comprises 1.50 percent weight of the antimicrobial composition.

7. The antimicrobial composition of claim 1, in which the antimicrobial composition is configured to be applied on skin.

8. The antimicrobial composition of claim 1, further comprising a zinc salt.

9. The antimicrobial composition of claim 8, in which the zinc salt is zinc sulfate, zinc gluconate, or combinations thereof.

10. An antimicrobial cleansing product exhibiting increased efficacy, comprising:
a container;
an antimicrobial composition housed within the container, wherein the antimicrobial composition comprises:
a cationic active ingredient comprising benzethonium chloride at a concentration of 0.1 to 0.2 weight percent of the antimicrobial composition;
a lauramine oxide surfactant at a concentration of 0.9 to 1.9 weight percent of the antimicrobial composition;
one or more co-surfactants selected from the group consisting of cocamidopropyl betaine, sunfloweramidopropyl ethonium sulfate, PEG-120 methyl glucose dioleate, lauryl/myristyl amidopropyl amine oxide, and lauramidopropylamine oxide;
one or more thickeners selected from the group consisting of hydromethylcellulose, PEG-120 methyl glucose, cocamide MEA, and hydroxypropyl methylcellulose; and
an aqueous carrier to contain the antimicrobial cleaning product.

11. The product of claim 10, in which the antimicrobial composition is a gel.

12. The product of claim 10, in which the antimicrobial composition is a foam.

13. The product of claim 10, in which the container comprises an opening that allows the antimicrobial composition to flow out of the container.

14. The product of claim 10, in which the antimicrobial composition is configured to be applied on skin.

15. The product of claim 10, in which the antimicrobial composition facilitates at least a log 2 reduction in a bacterial population.

16. The product of claim 10, in which the antimicrobial composition further comprises a zinc salt.

17. (canceled)

18. An antimicrobial composition exhibiting increased efficacy, comprising:
0.10% to 0.20% by weight of benzethonium chloride disposed within the antimicrobial composition;
0.9% to 1.9% by weight of a lauramine oxide surfactant disposed within the antimicrobial composition;
one or more co-surfactants disposed within the antimicrobial composition; and
a thickener disposed within the antimicrobial composition.

19. The antimicrobial composition of claim 18 in which the number of co-surfactants comprise cocamidopropyl betaine, sunfloweramidopropyl ethonium sulfate, PEG-120 methyl glucose dioleate, lauryl/myristyl amidopropyl amine oxide, lauramidopropylamine oxide, or combinations thereof.

20. The antimicrobial composition of claim 18 in which the thickener comprises hydromethylcellulose, PEG-120 methyl glucose, cocamide MEA, hydroxypropyl methylcellulose, or combinations thereof.
